(19) United States
(12) Patent Application Publication
(10) Pub. No.: US 2026/0006421 A1
(43) Pub. Date: Jan. 1, 2026

(54) EMERGENCY COMMUNICATIONS AVAILABILITY DETERMINATION

(71) Applicant: T-Mobile USA, Inc., Bellevue, WA (US)

(72) Inventor: Anthony Samuel Jones III, Ewa Beach, HI (US)

(21) Appl. No.: 18/755,083

(22) Filed: Jun. 26, 2024

(51) Int. Cl. H04W 4/90; H04M 1/72418

(52) U.S. Cl. CPC H04W 4/90; H04M 1/72418

(57) ABSTRACT

System and methods for performing emergency communications availability determinations are disclosed. Network components may be configured to determine the activity status of public safety access points (PSAPs) in a network, the areas the PSAPs are associated with, and their particular function relative to those areas. This information may be provided to user equipment (UEs) that may use this information along with signal data to determine a particular graphical element to present on an interface that indicates the level of emergency communications services available to the UE at the present time.

### BACKGROUND

The number of wireless communications devices in use has grown exponentially, along with the number of communications networks used to support such devices. Along with usage for typical communications and data exchanges, wireless communications devices may be useful in emergency situations. For example, when an accident or other emergency situation arises, it can be very beneficial to those affected to have access to a wireless communications device that may be operated to rapidly contact emergency services (e.g., police, fire department, ambulance, etc.).

Situations may arise that may increase the likelihood of an emergency happening. For example, if a tornado, hurricane, or other storm is occurring or imminent, a user may wish to determine that emergency services are available and reachable via the user's wireless communications device in case an emergency arises. However, without actually initiating an emergency communications (e.g., call or text to 911), the user may not be able to confirm access to emergency services via the user's wireless communications device. Initiating an emergency communication just to test whether such communications may be successful (e.g., when there is no actual emergency occurring) is a waste of valuable resources that may be better dedicated to addressing current emergencies. It is currently difficult to determine emergency communications connectivity without actually contacting or otherwise involving emergency services and wasting important resources that should be reserved for emergency situations.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communication network environment in which systems and techniques for determining emergency communications availability may be implemented, in accordance with examples of the disclosure.

FIG. 2 is a diagram of an illustrative signal flow associated with systems and techniques for determining emergency communications availability, in accordance with examples of the disclosure.

FIG. 3 is a pictorial flow diagram of an illustrative process for determining emergency communications availability for public safety access points (PSAPs), in accordance with examples of the disclosure.

FIG. 4 is a flow diagram of an illustrative process for determining emergency communications availability for a user equipment (UE), in accordance with examples of the disclosure.

FIG. 5 illustrates examples of user interfaces and data structures that may be generated and processed in systems and techniques for determining emergency communications availability, in accordance with examples of the disclosure.

FIG. 6 illustrates further examples of user interfaces and data structures that may be generated and processed in systems and techniques for determining emergency communications availability, in accordance with examples of the disclosure.

FIG. 7 illustrates an example of data and a data structure that may be generated and processed in systems and techniques for determining emergency communications availability, in accordance with examples of the disclosure.

FIG. 8 is a schematic diagram of illustrative components in an example user device that may be configured for determining emergency communications availability, in accordance with examples of the disclosure.

FIG. 9 is a schematic diagram of illustrative components in an example computing device that may be configured for determining emergency communications availability, in accordance with examples of the disclosure.

### DETAILED DESCRIPTION

### Overview

This disclosure is directed in part to systems and techniques for determining emergency communications availability for a user equipment (UE) (e.g., smartphone, cell phone, mobile device, wireless communication device, mobile station, etc.) in advanced wireless communications networks. Such advanced networks include networks that support one or more 3GPP standards, including, but not limited to, Long Term Evolution (LTE) networks (e.g., 4G LTE networks) and New Radio (NR) networks (e.g., 5G NR networks). However, the disclosed systems and techniques may be applicable in any network or system in which a user device may request and receive access to communicate with emergency services and/or systems using any protocol. In examples, the disclosed techniques may be implemented in systems that use Wi-Fi and other local and/or short range wireless communications technologies to connect user devices to a network. In further examples, the disclosed techniques may be implemented in systems that use wired communications connections to connect user devices to a network.

Emergency communications may include any one or more communications initiated from a UE to an emergency services provider, such as a 911 call or a text to 911. Such emergency communications may be routed to a public safety access point (PSAP) that is the closest (e.g., geographically most proximate) available (e.g., active) PSAP to the current location of the UE from among available PSAPs. Note that “PSAP” as used herein refers to any one or more systems, components, devices, and/or functions that may be configured at or otherwise associated with a PSAP and configured to interact with a wireless communication network and/or perform one or more operations described herein.

A PSAP may be configured to receive such emergency communications and provide them to one or more human operators and/or emergency services systems associated with a particular geographical area. In examples, a base station may be configured to direct emergency communications to a PSAP that is associated with an area with which the base station is also associated. Alternatively or additionally, an emergency communication may include an indication of a current geographical location of the originating device (e.g., UE). This location may be determined by the UE and/or one or more systems within the network supporting the UE for inclusion in the emergency communication. For example, a UE may include location determination components and/or services, such as GPS components, that may determine a current geographical location of a wireless communications device that may be included in an emergency communication initiated by the UE. In examples, this location information determined by a UE may be used to determine the appropriate PSAP for emergency communications originating at the UE.

Various operations may be performed within a wireless communications network in order to determine a correct PSAP for an emergency communication and to provide the emergency communication and relevant data to the PSAP. In examples, a particular area may be serviced by one or more specific (e.g., primary) PSAPs. This area may be a geographical area associated with a wireless communications coverage area of one or more base stations. To ensure that emergency communications are properly addressed in the event of a PSAP failure, one or more primary PSAPs may also be associated with one or more back-up (e.g., redirection) PSAPs to which the network may route emergency communications in the event that a primary PSAP in unavailable.

A wireless communications network may include one or more PSAP status nodes that may each be an individual and distinct component or function of the network or configured at one or more other network nodes that may perform other functions. Among the operations that may be performed by a PSAP status node is monitoring or otherwise determining an operational status for various PSAPs configured in and/or in communication with a network. This monitoring may include proactively probing PSAPs (e.g., on a regular schedule) for status (e.g., to determine if the probed PSAPs are reachable via the network and responding normally). Alternatively or additionally, this monitoring may include receiving, at a PSAP status node, proactively generated status data from the PSAPs. In such examples, a PSAP status node may determine that a PSAP is inactive when the PSAP status node has not received a status update from that PSAP for a threshold amount of time or number of other status update intervals.

Properly processed emergency communications are transmitted to a primary PSAP that is most geographically proximate to the originating device and/or the base station with which the originating device is communicating to ensure the most rapid response from first responders and to assist in emergency response activities. In the event that the primary PSAP is unavailable, the emergency communications may be transmitted to a redirection PSAP serving as a back-up PSAP to the primary PSAP. This redirection PSAP may be the next most geographically proximate PSAP to the originating device and/or the base station. An area emergency status component may maintain current PSAP status data for a particular area (e.g., based on data received from a PSAP status node) to ensure that proper routing is used for emergency communications in that area. In some examples, an area emergency status component may also, or instead, maintain a listing or other data (e.g., a “whitelist”) indicating UEs that are permitted to access particular PSAPs (as primary and/or redirection PSAPs). In examples, an area emergency status component may be a component or function of a base station and/or one or more other components of the network (e.g., configured at a gateway, node, and/or at any other physical and/or logical component or function of the network). In other examples, an area emergency status component may be configured as a distinct physical and/or logical component or function within the network and in communication with one or more UEs via one or more base stations. An area emergency status component may further be in communication with one or more PSAP status nodes via the core of a wireless communications network. In examples, a PSAP status node and an area emergency status component may be implemented as a single component or function, independently as a distinct physical and/or logical entity within the network or as a component or function of another physical and/or logical entity within the network.

The disclosed systems and techniques may be used to determine and generate indications of emergency communications availability without requiring involving actual emergency services systems and personnel in the emergency communications availability determination process. In various examples, an area emergency status component may transmit area PSAP status data to a UE via a base station. In some examples, the area emergency status component may also, or instead, transmit an indication (e.g., whitelist indicator) to such UEs indicating whether those UEs are permitted to access particular PSAPs (as primary and/or redirection PSAPs). The UE may be configured with an emergency status component that may determine current PSAP status data for the UE based on the area PSAP status data. The emergency status component may further determine current signal data (e.g., signal strength data, signal power data, etc.) for the UE based on wireless communications with the base station. The emergency status component may process this area PSAP status data and signal data to determine a UE emergency status. In some examples, the emergency status component may also determine whether the UE is associated with a whitelist (e.g., based on an indicator received from the area emergency status component) for the associated PSAPs and use this determination in determining the UE emergency status (e.g., if the UE is not whitelisted for a PSAP, then the lack of access to that PSAP is expected and therefore does not indicate a lack of emergency communications availability). The emergency status component may then determine an indicator corresponding to the UE emergency status and generate an interface for presentation on the UE that includes the indicator. While described as being configured on a UE in some examples, an emergency status component may be configured on a network component (e.g., at a base station, a network node, an area emergency status component, etc.) and may transmit UE emergency status data to the UE for use in generating one or more interfaces on the UE that may include associated emergency status indicators.

By facilitating the efficient and accurate determination of emergency communications availability, systems and methods described herein can improve the performance and increase the efficiency of network resources (and therefore UE resources), while improving the user experience by ensuring that emergency communications are properly processed. Furthermore, the systems and methods described herein can increase the efficiency of emergency services systems and components by preventing the unnecessary initiating of emergency communications is situations that are not legitimately emergency (e.g., testing the availability of emergency communications). For example, the methods and systems described herein may be more efficient and/or more robust than conventional techniques, as they may allow a user to determine the availability of emergency communications without interfering with operational emergency services.

Moreover, the methods and systems described herein provide a technological improvement over existing emergency communications testing systems and processes by facilitating an improved user experience and increasing network efficiency by reducing the utilization of network resources for processing emergency communications that are not associated with actual emergencies, but instead used to test emergency communications availability. This may be an especially significant efficiency improvement at times when emergency services are likely to be in high demand, such as during a significant weather event, natural disaster, etc. At such times, while many users may be initiating legitimate emergency communications, other users may be interested in determining whether emergency communications are available. By providing users with an indication of the availability of current emergency communications that does not involve actual use of emergency services or communications systems, the systems and methods described herein can provide more robust systems by, for example, making more efficient use of network devices and user devices by reducing unnecessary and/or unproductive device and network usage for merely testing emergency communications, thereby freeing network and emergency services resources for more productive operations, including processing legitimate emergency communications. Providing users with an indication of the availability of current emergency communications as described herein may also provide information to users that reassures such users that emergency services are within reach or notifies users that emergency services may not be within reach, which may allow such users to take steps to maintain safety.

Illustrative environments, signal flows, and techniques for implementing systems and techniques for emergency communications availability determination are described below. However, the described systems and techniques may be implemented in other environments.

### Illustrative System Architecture

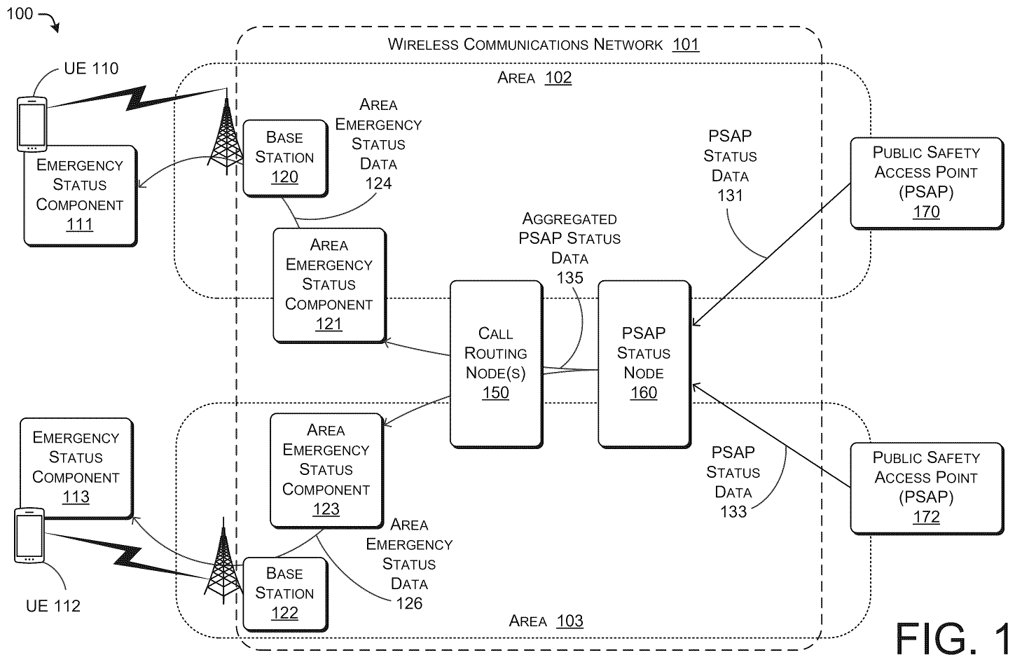

FIG. 1 is a schematic diagram of an illustrative wireless network environment 100 in which the disclosed systems and techniques may be implemented. The environment 100 may include a UE 110 that may wirelessly communicate with a base station 120. While referred to as a “base station” for explanatory purposes herein, the base station 120 may be any type of base station, including, but not limited to, any type of base transceiver station (BTS), NodeB, eNodeB, gNodeB, etc. The base station 120 may communicate with other devices and elements in the core of a wireless communications network 101. The environment 100 may also include a UE 112 that may wirelessly communicate with a base station 122 that may also be any type of base station, including, but not limited to, any type of BTS, NodeB, eNodeB, gNodeB, etc. The base station 122 may also communicate with other devices and elements in the core of a wireless communications network 101. Such devices and elements in the core of a wireless communications network 101 are represented as call routing node(s) 150 in FIG. 1 and may include any core network components, functions, devices, and/or systems of any type, including any 3G, 4G, 5G, and 6G components and/or functions.

The wireless communications network 101 may be any one or more networks that facilitate communications between devices of various types, such as computing devices and mobile devices (e.g., UEs). Various connections between devices in the network 101 may be wired, wireless, or a combination thereof. In various embodiments, the wireless communications network 101 may facilitate communications with one or more wireless devices, such as UEs. The wireless communications network 101 may facilitate packet-based communications between such wireless devices and devices on the Internet and/or one or more systems and devices internal or external to the wireless communications network 101, such as PSAP 170 and PSAP 172.

The UE 110 may be in an area 102 that may be a geographical area associated with the location of the UE 110, the location of the base station 120, and/or the area of coverage provided by the base station 120. The area 102 may be a wireless communications network area for which the wireless communications network 101 provides wireless communications services. The PSAP 170 may be configured to facilitate emergency services within or proximate to the area 102. To facilitate such services, the PSAP 170 may be configured to exchange emergency communication with UEs and other devices within and/or proximate to the area 102, such as the UE 110, via the wireless communications network 101. An area emergency status component 121 may be configured to determine PSAP status data and/or other emergency communications status data associated with the area 102. The area emergency status component 121 may be configured to provide area emergency status data 124 to the UE 110 via the base station 120. In examples, the area emergency status component 121 may be configured at a gateway mobile location center (GMLC), the base station 120, and/or any other node, component, or function of the wireless communications network 101. Alternatively, the area emergency status component 121 may be a separate and distinct physical and/or logical node, component, or function of the wireless communications network 101.

The UE 112 may be in an area 103 that may be a geographical area associated with the location of the UE 112, the location of the base station 122, and/or the area of coverage provided by the base station 122. The area 103 may be a wireless communications network area for which the wireless communications network 101 provides wireless communications services. The PSAP 172 may be configured to facilitate emergency services within or proximate to the area 103. To facilitate such services, the PSAP 172 may be configured to exchange emergency communication with UEs and other devices within and/or proximate to the area 103, such as the UE 112, via the wireless communications network 101. An area emergency status component 123 may be configured to determine PSAP status data and/or other emergency communications status data associated with the area 103. The area emergency status component 123 may be configured to provide area emergency status data 126 to the UE 112 via the base station 122. In examples, the area emergency status component 123 may be configured at a gateway mobile location center (GMLC), the base station 122, and/or any other node, component, or function of the wireless communications network 101. Alternatively, the area emergency status component 123 may be a separate and distinct physical and/or logical node, component, or function of the wireless communications network 101.

The one or more call routing nodes 150 may be any one or more routing nodes of any type configured to route or otherwise facilitate voice calls and/or the exchange of any type of data. The UE 110 and the UE 112 may exchange data with remote devices, such as the PSAPs 170 and 172, respectively, using the call routing nodes 150 via the base station 120 and the base station 122, respectively.

A PSAP status node 160 may be configured in the wireless communications network 101 for determining and storing status data for one or more PSAPs that may communicate with other devices via the wireless communications network 101. For example, the PSAP 170 may provide the PSAP status node 160 with PSAP status data 131. Likewise, the PSAP 172 may provide the PSAP status node 160 with PSAP status data 133. The PSAP status node 160 may also receive PSAP status data from one or more other PSAPs. Such status data may be generated and transmitted to the PSAP status node 160 in response to queries from the PSAP status node 160. Alternatively or additionally, PSAPs, such as the PSAPs 170 and 172, may be configured to proactively transmit PSAP status data to status nodes such as the PSAP status node 160.

The PSAP status node 160 may process received PSAP status data to generate aggregated SAP status data 135 that may be transmitted to one or more area emergency status components, such as area emergency status component 121 and area emergency status component 123. The aggregated SAP status data 135 generated by the PSAP status node 160 may be based on PSAP status data received from PSAPs and may be augmented with additional data generated by the PSAP status node 160. For example, the PSAP status node 160 may determine the available PSAPs for each area along with redirection PSAPs for each area and so forth. The PSAP status node 160 may generate data identifying the areas services by particular PSAPs, identifiers (e.g., network addresses, etc.) for the PSAPs corresponding to particular areas, etc. This data may be represented in the aggregated PSAP status data 135.

The PSAP status node 160 may transmit the aggregated PSAP status data 135 to the area emergency status component 121 and/or to the area emergency status component 123 via the call routing node(s) 150. The area emergency status component 121 and/or the area emergency status component 123 may process this PSAP status data to determine PSAP status data for their respective areas and transmit such data to UEs in that area. For example, the area emergency status component 121 may determine, based on the aggregated PSAP status data 135, that the PSAP 170 is active and providing primary PSAP service for the area 102 associated with the area emergency status component 121. The area emergency status component 121 may further determine, based on the aggregated PSAP status data 135, that the PSAP 172 is active and providing redirection PSAP service for the area 102. Alternatively, the area emergency status component 121 may determine, based on the aggregated PSAP status data 135, that the PSAP 170 is inactive and not capable of currently providing primary PSAP service for the area 102, but that the PSAP 172 is active and providing redirection PSAP service for the area 102. In another alternative, the area emergency status component 121 may determine, based on the aggregated PSAP status data 135, that the PSAP 170 is active providing primary PSAP service for the area 102, but that the PSAP 172 is inactive and not currently capable of providing redirection PSAP service for the area 102. As will be appreciated, any combination of PSAP statuses may be determined by an area emergency status component. The area emergency status component 123 may be similarly configured and capable of determining PSAP status data for its area (103). Further examples of such operations are set forth herein.

The area emergency status component 121 may generate the area emergency status data 124 based on the processing of the aggregate PSAP status data 135. The area emergency status component 121 may transmit the area emergency status data 124 to the UE 110 via the base station 120. Similarly, the area emergency status component 123 may generate the area emergency status data 126 based on the processing of the aggregate PSAP status data 135. The area emergency status component 123 may transmit the area emergency status data 126 to the UE 112 via the base station 122.

The UE 110 may include or be configured with an emergency status component 111 that may determine emergency status data for the UE 110 based on the area emergency status data 124. The emergency status component 111 that may further determine emergency status data for the UE 110 based on signal data determined at the UE 110 and/or received from the base station 120. For example, the emergency status component 111 may take into account a received and/or transmitted signal strength to determine emergency status data for the UE 110. The emergency status component 111 may then determine, based on the UE 110's determined emergency status data, an appropriate indicator to present on an interface generated and displayed at the UE 110.

The UE 112 may include or be configured with an emergency status component 113 that may determine emergency status data for the UE 112 based on the area emergency status data 126. The emergency status component 113 that may further determine emergency status data for the UE 112 based on signal data determined at the UE 112 and/or received from the base station 122. For example, the emergency status component 113 may take into account a received and/or transmitted signal strength to determine emergency status data for the UE 112. The emergency status component 113 may then determine, based on the UE 112's determined emergency status data, an appropriate indicator to present on an interface generated and displayed at the UE 112. More details are provided herein describing the various indicators contemplated and the status data associated therewith.

By exchanging and processing PSAP and emergency status data as described herein, the UEs 110 and 112 may present to their respective users an indication of a current emergency communications availability without actually initiating an emergency communication of any kind. This prevents the unnecessary processing and routing of data associated with emergency communications when a user merely wishes to know the availability of emergency communications and is not currently experiencing an emergency. This also prevents wasting the time of emergency services personnel responding to emergency communications that are sent just to test emergency communications availability.

Note that the components, systems, services, and functions represented in the environment 100 are an exemplary subset of components, systems, services, and functions that may be configured in a wireless communications environment. One skilled in the art will recognize that many other components, systems, services, and functions may be configured in such an environment and interact with the components, systems, services, and functions represented in FIG. 1.

### Illustrative Signal Flows

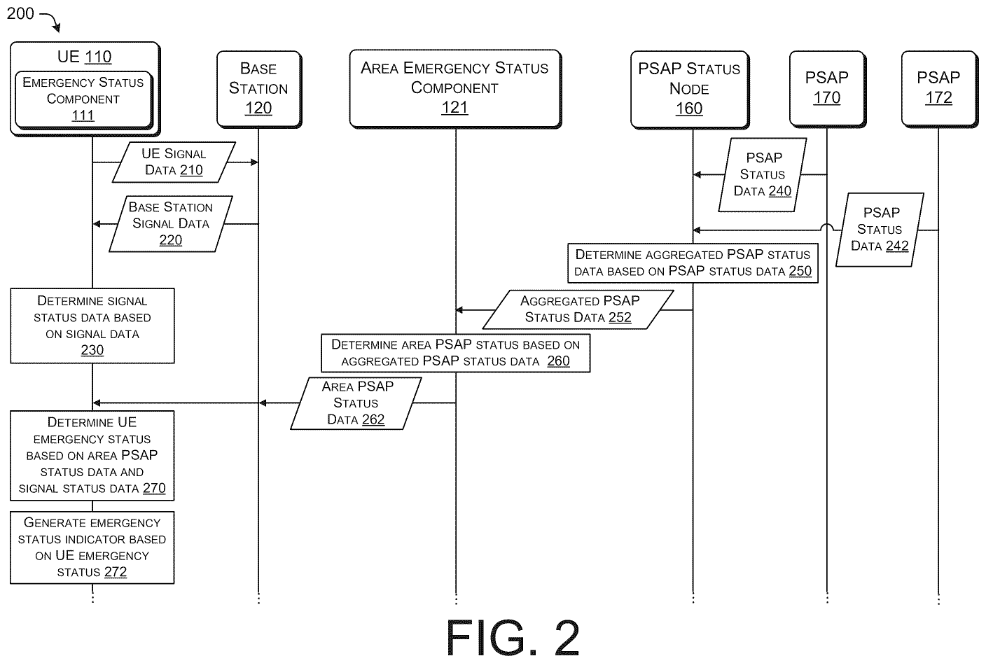

FIG. 2 illustrates an exemplary signal flow 200 of various messages that may be exchanged in one or more of the disclosed systems and techniques for more efficiently and accurately determining emergency communications availability. Reference may be made in this description of the signal flow 200 to devices, entities, and data illustrated in FIG. 1 and described in regard to that figure. However, the operations, signals, and signal flow illustrated in FIG. 2 and described herein may be implemented in any suitable system and/or with any one or more suitable devices and/or entities. Moreover, any of the operations, signals, and/or entities described in regard to FIG. 2 may be used separately and/or in conjunction with other operations, signals, and/or entities. All such embodiments are contemplated as within the scope of the instant disclosure.

The UE 110 may transmit UE signal data 210 to the base station 120. The UE signal data 210 may be any wireless signal transmitted by the UE 110 to the base station 120, such as a signal transmitted as part of a typical wireless communication. Alternatively or additionally, the UE signal data 210 may be a signal intended for use by the base station 120 in determining a signal strength (e.g., received signal strength) associated with the UE 110. In examples, the base station 120 may determine a reference signal received power (RSRP) based on the signal representing the UE signal data 210 transmitted by the UE 110.

The base station 120 may transmit base station signal data 220 to the UE 110. The base station signal data 220 may be any wireless signal transmitted by the base station 120 to the UE 110, such as a signal transmitted as part of a typical wireless communication. Alternatively or additionally, the base station signal data 220 may be a signal intended for use by the UE 110 in determining a signal strength (e.g., received signal strength) associated with the base station 120. In examples, the UE 110 may determine an RSRP based on the signal representing the base station signal data 220 transmitted by the base station 120.

Alternatively, the base station signal data 220 may indicate the signal strength determined by the base station 120 based on the UE signal data 210. For example, the base station signal data 220 may include an RSRP value determined by the base station 120 for the UE signal data 210. Any other signals may be exchanged by the UE 110 and the base station 120 and used to determine any other forms of signal quality measurements (e.g., power, strength, direction, etc.).

At operation 230, the UE 110 and/or the emergency status component 111 (e.g., configured at the UE 110 and/or interacting with the UE 110) may determine signal status data for the UE. For example, and as described in more detail herein, the UE 110 and/or the emergency status component 111 may determine whether a signal strength of the signal received at the UE 110 from the base station 120 and/or the signal transmitted to the base station 120 from the UE 110 is above a no signal threshold and/or above a low signal threshold. The UE 110 and/or the emergency status component 111 The PSAP 170 may store an indication of this determination for use in determining an emergency status indicator as described herein.

The PSAP 170 may transmit PSAP status data 240 to the PSAP status node 160. The PSAP status data 240 may include an indication of the availability of the PSAP 170 to perform PSAP duties (e.g., “active,” “inactive,” etc.) as well as an indication of one or more areas for which the PSAP 170 is available to serve as a primary PSAP. The PSAP status data 240 may further include an indication of the availability of the PSAP 170 to perform redirection PSAP duties (e.g., “active,” “inactive,” etc.) as well as an indication of one or more areas for which the PSAP 170 is available to serve as a redirection PSAP.

Similarly, the PSAP 172 may transmit PSAP status data 242 to the PSAP status node 160. The PSAP status data 242 may include an indication of the availability of the PSAP 172 to perform PSAP duties (e.g., “active,” “inactive,” etc.) as well as an indication of one or more areas for which the PSAP 172 is available to serve as a primary PSAP. The PSAP status data 242 may further include an indication of the availability of the PSAP 172 to perform redirection PSAP duties (e.g., “active,” “inactive,” etc.) as well as an indication of one or more areas for which the PSAP 170 is available to serve as a redirection PSAP.

Note that the failure of the PSAP status node 160 to receive one or both of the PSAP status data 240 and the PSAP status data 242 may also be used by the PSAP status node 160 to determine PSAP status. For example, if the PSAP status node 160 fails to receive any PSAT status data from the PSAP 170, for example for at least a threshold period of time, the PSAP status node 160 may determine that the PSAP 170 is not available. If the PSAP status node 160 subsequently resumes receiving status data from the PSAP 170, the PSAP status node 160 may determine an updated status for the PSAP 170 based on such status data.

At operation 250, the PSAP status node 160 may determine aggregated PSAP status data 252 based on PSAP status data received from the various PSAPs with which it may be in communication. For example, the PSAP status node 160 may generate a data structure that associated PSAP (e.g., by identifiers, such as network addresses and/or numbers) with PSAP status indicators (e.g., “active,” “inactive,” etc.), areas, and area role (e.g., “primary” or “redirection”). The PSAP status node 160 may then transmit this aggregated PSAP status data 252 to one or more area emergency status components, such as area emergency status component 121.

At operation 260, the area emergency status component 121 may determine PSAP status for the particular area with which it is associated. For example, the aggregated PSAP status data 252 may include PSAP status data for several areas, at least some of which may be areas that are not associated with the area emergency status component 121. In such examples, the area emergency status component 121 may extract the data associated with its area from the aggregated PSAP status data 252 to generate a data structure representing area PSAP status data 262 for the area emergency status component 121. For example, the area emergency status component 121 may determine, from the aggregated PSAP status data 252, status data for one or more PSAPs that may serve a primary PSAP for its area and status data for one or more PSAPs that may serve a redirection PSAP for its area. The area emergency status component 121 may generate a data structure representing this area PSAP status data 262 and transmit the area PSAP status data 262 to one or more UEs via a base station. In this example, the area emergency status component 121 may transmit the area PSAP status data 262 to the UE 110 and/or its emergency status component 111 via the base station 120.

At operation 270, the UE 110 and/or the emergency status component 111 may determine emergency communications status for the UE 110 based on the area PSAP status data 262 received from the area emergency status component 121 and/or the signal status data determined at operation 230. This determination may also account for UE whitelist status for the PSAPs represented in the area PSAP status data 262 (e.g., that may be based on PSAP status data 240 and/or 242, and/or determined by PSAP status node 160 for inclusion in the aggregated PSAP status data 252). As described herein, there are a variety of PSAP and signal status combinations that may be determined, such as the availability of one or more primary PSAPs, the availability of one or more redirection PSAPs, and whether the signal status is “no signal,” “low signal,” or “full signal.”

At operation 272, the UE 110 and/or the emergency status component 111 may determine the emergency communications availability indicator that corresponds to the particular combination of PSAP and signal statuses determined at operation 270. The UE 110 may, further at operation 272, present this indicator on an interface on a display of the UE 110.

### Illustrative Operations

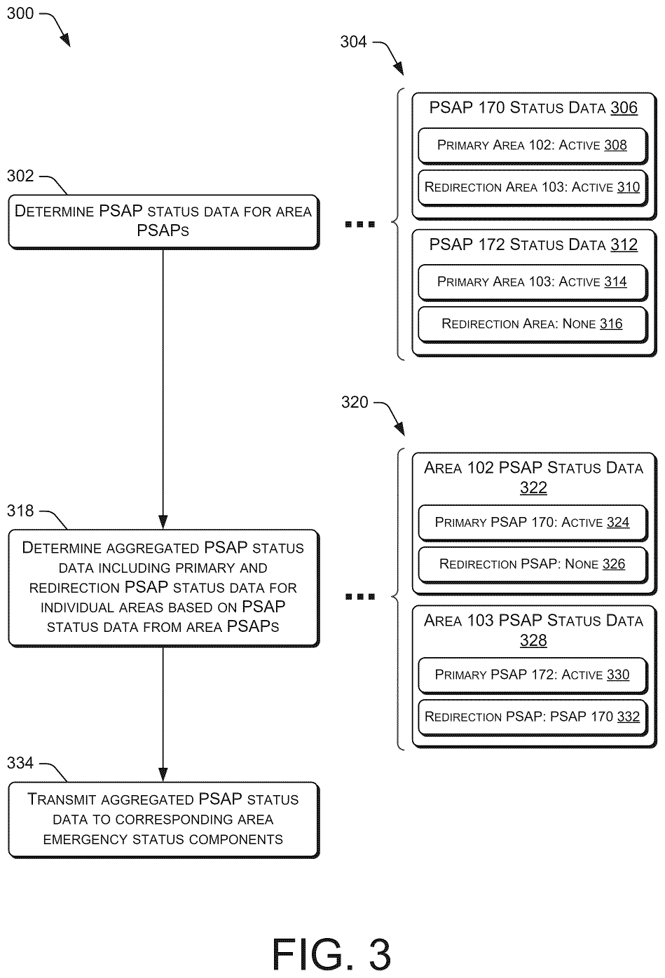

FIG. 3 shows a flow diagram of an illustrative process 300 for performing emergency communications availability determination for one or more areas according to the disclosed embodiments. The process 300 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 300 may be described with reference to the wireless network environment 100 of FIG. 1; however other environments may also be used. While a PSAP status node is described in regard to this exemplary process, one or more other components or functions in a system, such as an area emergency status component, may perform any one or more of the operations described herein.

At block 302, a PSAP status node may receive or otherwise determine PSAP status data for one or more PSAPs. In examples, the PSAP status node may query or otherwise request PSAP status data from one or more PSAPs that may then be responsively transmitted from the queried PSAPs to the PSAP status node. Alternatively or additionally, the PSAP status node may determine PSAP status using other means. For example, one or more PSAPs may be configured to automatically or proactively transmit PSAP status data to one or more PSAP status nodes. In other examples, the PSAP status node may also, or instead, be configured to obtain or receive PSAP status data from one or more other resources, such as a PSAP status data database or system configured to maintain such PSAP status data.

An example 304 is a block diagram representing exemplary data structures that may be used to represent PSAP status data. A PSAP 170 status data 306 data structure may represent the PSAP status data that may be provided by the example PSAP 170 of FIG. 1. Data unit 308 of the PSAP 170 status data 306 may include data indicating that the PSAP 170 is serving as a primary PSAP for area 102 of the example environment 100 of FIG. 1 and that the PSAP 170 is currently active as that primary PSAP. Data unit 310 of the PSAP 170 status data 306 may include data indicating that the PSAP 170 is serving as a redirection PSAP for area 103 of the example environment 100 of FIG. 1 and that the PSAP 170 is currently active as that redirection PSAP. Note that in other examples, the PSAP 170 status data 306 may indicate activity status of the PSAP 170 (e.g., only) and not specific areas and/or primary/redirection status. In such examples, the PSAP status node may determine applicable areas for PSAP and/or may determine whether such PSAPs are primary or redirection PSAPs for such areas. Note that other data may also, or instead, be included in the PSAP 170 status data 306, including PSAP network addresses and/or numbers.

The example 304 further includes a PSAP 170 status data 312 data structure that may represent the PSAP status data that may be provided by the example PSAP 172 of FIG. 1. Data unit 314 of the PSAP 172 status data 312 may include data indicating that the PSAP 172 is serving as a primary PSAP for area 103 of the example environment 100 of FIG. 1 and that the PSAP 172 is currently active as that primary PSAP. Data unit 316 of the PSAP 172 status data 312 may include data indicating that the PSAP 172 is not serving as a redirection PSAP. As with the PSAP 170 status data 306, the PSAP 172 status data 312 may indicate activity status of the PSAP 172 (e.g., only) and not specific areas and/or primary/redirection status. In such examples, the PSAP status node may determine applicable areas for PSAP and/or may determine whether such PSAPs are primary or redirection PSAPs for such areas. Note that other data may also, or instead, be included in the PSAP 172 status data 312, including PSAP network addresses and/or numbers.

Either or both of the PSAP 170 status data 306 and the PSAP 172 status data 312 may include data indicating one or more UEs or groups of UEs that are authorized to access the respective PSAP (e.g., whitelisted UEs) and/or that are not authorized to access the respective PSAP (e.g., blacklisted UEs). This data may be propagated to one or more area emergency status components that may receive the PSAP 170 status data 306 and the PSAP 172 status data 312 from the PSAP status node(s). Alternatively or additionally, the PSAP status node(s) and/or the area emergency status component(s) may maintain and/or generate one or more whitelists and/or one or more blacklists for UEs and/or groups of UEs that may be associated with one or more PSAPs.

In examples, the PSAP status node may determine PSAP status data for one or more PSAPs based on an absence of PSAP status data. For example, the PSAP status node may be configured to periodically query a particular PSAP or to expect a PSAP status data update from that particular PSAP periodically. If the PSAP status node does receive PSAP status data from that PSAP for a threshold period (e.g., a threshold period of time, a threshold number of unanswered queries, etc.), the PSAP status node may set the status of the PSAP to “inactive” or some other indicator that that PSAP is not reachable or responsive (e.g., unavailable to serve as a primary or redirection PSAP).

At block 318, the PSAP status node may determine aggregated PSAP status data by generating a data structure representing the primary and redirection PSAPs associated with particular areas. This data structure may then be used by other components and/or functions (e.g., area emergency status components, base stations, emergency status components, etc.) to determine particular PSAPs associated with particular areas. For example, the PSAP status node may use generate area PSAP status data structures for individual areas indicating one or more primary PSAPs for each such area and/or one or more redirection PSAPs for each such area (or data indicating no applicable PSAPs for an area).

An example 320 is a block diagram representing exemplary data structures that may be used to represent area PSAP status data. An area 102 PSAP status data 322 data structure may represent the PSAP status data that may be associated with the area 102 of FIG. 1, in examples, as determined by the PSAP status node based on the PSAP status data of the example 304. Data unit 324 of the area 102 PSAP status data 322 may include data indicating that the primary PSAP for the area 102 is the PSAP 170 of the example environment 100 of FIG. 1 and that the PSAP 170 is currently active as that primary PSAP. Data unit 326 of the area 102 PSAP status data 322 may include data indicating that there is no current redirection PSAP for the area 103. Note that other data may also, or instead, be included in the area 102 PSAP status data 322, including PSAP network addresses and/or numbers.

The example 320 further includes an area 103 PSAP status data 328 data structure that may represent the PSAP status data that may be associated with the area 103 of FIG. 1, in examples, as determined by the PSAP status node based on the PSAP status data of the example 304. Data unit 330 of the area 103 PSAP status data 328 may include data indicating that the primary PSAP for the area 103 is the PSAP 172 of the example environment 100 of FIG. 1 and that the PSAP 172 is currently active as the primary PSAP for that area. Data unit 332 of the area 103 PSAP status data 328 may include data indicating that the redirection PSAP for the area 103 is the PSAP 170 of the example environment 100 of FIG. 1 and that the PSAP 170 is currently active as the redirection PSAP for that area. Note that other data may also, or instead, be included in the area 103 PSAP status data 328, including PSAP network addresses and/or numbers.

At block 334, the PSAP status node may transmit the aggregated PSAP status data as determined at block 318 to one or more area emergency status components for processing as described herein. Alternatively or additionally, the PSAP status node may transmit or otherwise make this the aggregated PSAP status data available to one or more other components and/or functions, such as any other emergency status components, base stations, UEs, etc.

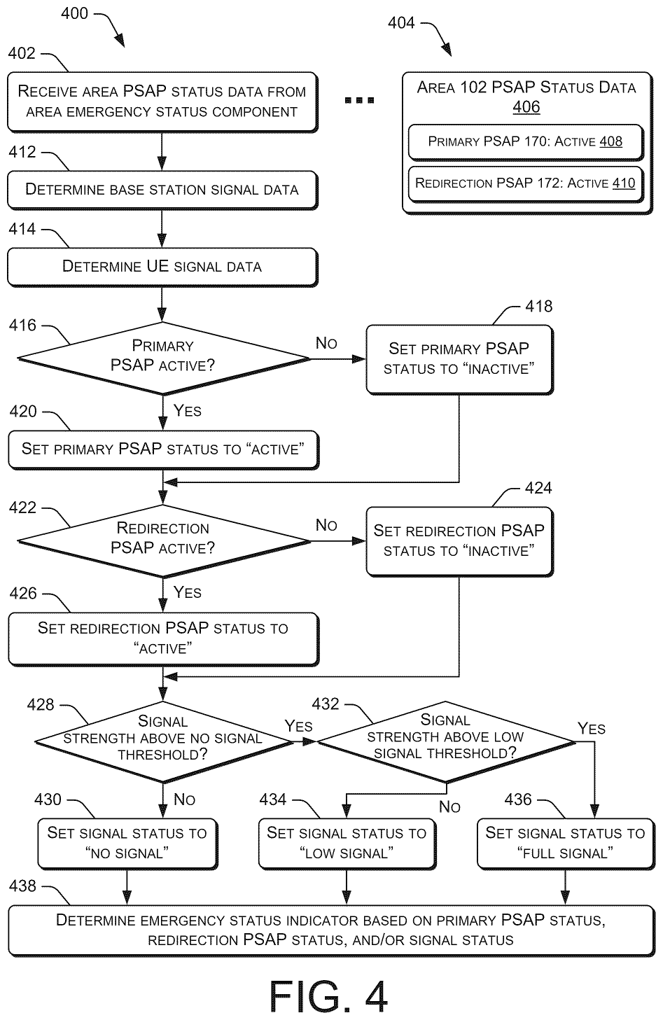

FIG. 4 shows a flow diagram of an illustrative process 400 for performing emergency communications availability determination according to the disclosed embodiments. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIG. 1; however other environments may also be used. While an emergency status component that may be configured at a UE and an area emergency status component configured at a wireless communications network are described in regard to this exemplary process, one or more other components or functions in a system, such as a base station, other components configured at a UE, any other type of emergency status component, and/or a PSAP status node, may perform any one or more of operations described herein.

At block 402, an emergency status component, for example, configured at a UE, may receive PSAP status data from an area emergency status component. This data may include PSAP status for the particular area within which the UE at which the emergency status component may be configured may be operating. This data may also include a whitelist and/or a blacklist indication that may indicate whether the UE is explicitly authorized or not authorized to access the particular PSAP. Alternatively, the area PSAP status data may include data for one or more area based upon which the emergency status component may determine PSAP status data for the area with which its UE may be associated.

An example 404 illustrates a block diagram representing an exemplary data structure that may be used to represent area PSAP status data. An area 102 PSAP status data 406 data structure may represent the PSAP status data that may be associated with the area 102 of FIG. 1, in examples, as determined by a PSAP status node based on PSAP status data. In this examples, the area 102 PSAP status data 406 may be received or otherwise accessed by a UE operating within the area 102, such as UE 110 of FIG. 1. Data unit 408 of the area 102 PSAP status data 406 may include data indicating that the primary PSAP for the area 102 is the PSAP 170 of the example environment 100 of FIG. 1 and that the PSAP 170 is currently active as that primary PSAP. Data unit 410 of the area 102 PSAP status data 406 may include data indicating that the redirection PSAP for the area 102 is the PSAP 172 of the example environment 100 of FIG. 1 and that the PSAP 172 is currently active as the redirection PSAP for that area. The area 102 PSAP status data 406 and/or the data units 408 and 410 may also include a whitelist and/or a blacklist indication that may indicate whether the UE is explicitly authorized or not authorized to access the particular PSAP (e.g., PSAP 170 and/or PSAP 172).

At block 412, the emergency status component may determine base station signal data. For example, the emergency status component may perform one or more operations to determine a strength, power, and/or other attribute(s) of a wireless communications signal transmitted by a base station and received by the UE at which the emergency status component may be configured. For instance, the emergency status component may determine an RSRP for a signal received from a base station. Alternately or additionally, the emergency status component may receive base station signal data from a base station (e.g., indicating base station signal strength, power, etc.).

At block 414, the emergency status component may determine UE signal data. For example, the emergency status component may perform one or more operations to determine a strength, power, and/or other attribute(s) of a wireless communications signal transmitted by the UE at which the emergency status component may be configured to, for example, a base station. For instance, the emergency status component may determine an RSRP for a signal transmitted by the UE. This may include receiving UE signal data from the base station indicating the strength, power, RSRP, and/or other attribute(s) of a wireless communications signal transmitted by the UE and received and measured by the base station. Alternately or additionally, the emergency status component may perform one or more operations to determine one or more attributes of a signal transmitted by the UE.

At block 416, the emergency status component may determine, for example, based on the area PSAP status data received at block 402, whether there is an active primary PSAP for the area associated with the UE at which the emergency status component may be configured. If there is no active primary PSAP for the area, at block 418, the emergency status component may set a primary PSAP status to “inactive” or otherwise store data indicating that there is currently no active primary PSAP for with the area with which the UE at which the emergency status component may be configured is associated. If there is an active primary PSAP for the area, at block 420, the emergency status component may set a primary PSAP status to “active” or otherwise store data indicating that there is currently an active primary PSAP for with the area with which the UE at which the emergency status component may be configured is associated. In some examples, the emergency status component may set this indicator contingent on whitelist or blacklist data. For instance, the emergency status component may not set a primary PSAP status to “active” for a UE that is indicated as not authorized to access the associated PSAP (e.g., blacklisted for that PSAP) and/or for a UE this is not explicitly indicated as authorized to access the associated PSAP (e.g., not whitelisted for that PSAP). The emergency status component may also store other data associated with the primary PSAP, including a PSAP identifier, network address, network number, whitelist data, blacklist data, etc. In some examples, the emergency status component may simply store an identifier, address, etc. of the primary PSAP if it is determined that there is an active primary PSAP for the area and may then later (as descried below) implicitly determine that there is an active primary PSAP based on the presence of a stored identifier for an active primary PSAP.

At block 422, the emergency status component may determine, for example, based on the area PSAP status data received at block 402, whether there is an active redirection PSAP for the area associated with the UE at which the emergency status component may be configured. If there is no active redirection PSAP for the area, at block 424, the emergency status component may set a redirection PSAP status to “inactive” or otherwise store data indicating that there is currently no active redirection PSAP for with the area with which the UE at which the emergency status component may be configured is associated. If there is an active redirection PSAP for the area, at block 426, the emergency status component may set a redirection PSAP status to “active” or otherwise store data indicating that there is currently an active redirection PSAP for with the area with which the UE at which the emergency status component may be configured is associated. As with the primary PSAP operations, in some examples, the emergency status component may set this indicator contingent on whitelist or blacklist data. For instance, the emergency status component may not set a redirection PSAP status to “active” for a UE that is indicated as not authorized to access the associated PSAP (e.g., blacklisted for that PSAP) and/or for a UE this is not explicitly indicated as authorized to access the associated PSAP (e.g., not whitelisted for that PSAP). The emergency status component may also store other data associated with the redirection PSAP, including a PSAP identifier, network address, network number, whitelist data, blacklist data, etc. In some examples, the emergency status component may simply store an identifier, address, etc. of the redirection PSAP if it is determined that there is an active redirection PSAP for the area and may then later (as descried below) implicitly determine that there is an active redirection PSAP based on the presence of a stored identifier for an active redirection PSAP.

At block 428, the emergency status component may determine if a signal strength (e.g., strength, power, other signal attribute) is above a no signal threshold strength or power. For example, the emergency status component may determine if the strength of the signal received from a base station (e.g., as determined at block 412) meets or exceeds a “no signal” threshold value. For instance, the emergency status component may determine if the strength of the signal received from a base station meets or exceeds a signal strength threshold value of −123 decibel-milliwatts (dBm). Alternately or additionally, the emergency status component may determine if the strength of the signal transmitted by the UE (e.g., as received at a base station and/or as determined at block 414) meets or exceeds a “no signal” threshold value. For instance, the emergency status component may determine if the strength of the signal received from the UE at a base station meets or exceeds a signal strength threshold value of −123 dBm.

If the, at block 428, the emergency status component determines that the signal strength does not meet or exceed the “no signal” threshold value, at block 430, the emergency status component may set the signal status to “no signal” or otherwise store data indicating that the UE does not currently have a sufficient signal for use in exchanging emergency communications.

If the determined signal strength meets or exceeds the “no signal” threshold value, at block 432, the emergency status component may determine if a signal strength (e.g., strength, power, other signal attribute) is above a low signal threshold strength or power. For example, the emergency status component may determine if the strength of the signal received from a base station (e.g., as determined at block 412) meets or exceeds a “low signal” threshold value. For instance, the emergency status component may determine if the strength of the signal received from a base station meets or exceeds a signal strength threshold value of −120 dBm. Alternately or additionally, the emergency status component may determine if the strength of the signal transmitted by the UE (e.g., as received at a base station and/or as determined at block 414) meets or exceeds a “low signal” threshold value. For instance, the emergency status component may determine if the strength of the signal received from the UE at a base station meets or exceeds a signal strength threshold value of −120 dBm.

If the, at block 432, the emergency status component determines that the signal strength does not meet or exceed the “low signal” threshold value, at block 434, the emergency status component may set the signal status to “low signal” or otherwise store data indicating that the UE currently has a low signal strength available for use in exchanging emergency communications.

If the, at block 432, the emergency status component determines that the signal strength meets or exceeds the “low signal” threshold value, at block 436, the emergency status component may set the signal status to “full signal” or otherwise store data indicating that the UE currently has a full, normal, or otherwise fully sufficient signal strength available for use in exchanging emergency communications.

At block 438, the emergency status component may determine an emergency communications availability indicator for inclusion in an interface generated and presented on the UE at which the emergency status component may be configured. This determination may be based on one or more of the signal status (e.g., as determined at blocks 428-436), the primary PSAP status (e.g., as determined at blocks 416-420), and the redirection PSAP status (e.g., as determined at blocks 422-426). Various indictors may be used to indicate the various possible emergency communications availability statuses and differentiate among them, as described in more detail herein

In summary, by more efficiently and accurately determining emergency communications availability without disrupting operational emergency services systems and personnel, the disclosed systems and techniques may be able to increase the efficiency of usage of emergency resources, UE resources, and wireless network resources, improving the user experience and performance of both the network and user devices.

### Example User Interfaces and Associated Data Structures

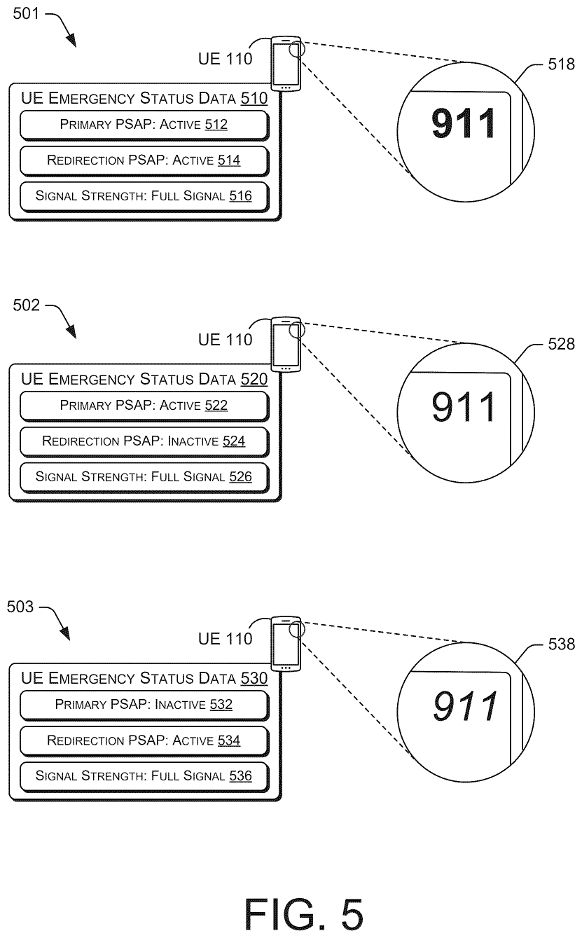

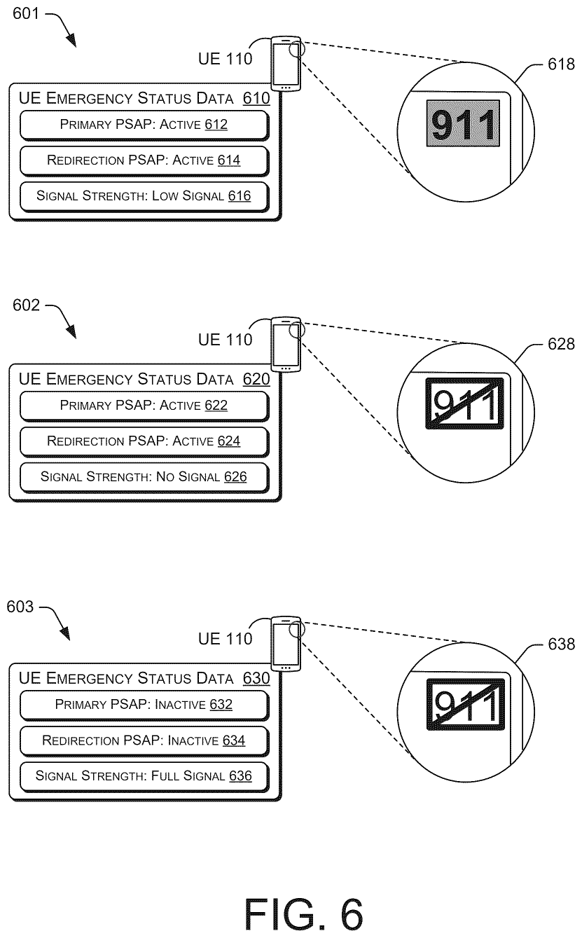

FIGS. 5-7 show graphical representations of exemplary data structures and/or graphical elements that may be generated based on such data structures. These graphical elements may be generated for inclusion in one or more graphical user interfaces that may be generated and presented to a user on a UE as described herein. For discussion purposes, the examples of FIGS. 5 and 6 may be described with reference to the wireless network environment 100 of FIG. 1; however, other environments may also be used. In particular, while the UE 110 of the exemplary environment 100 in FIG. 1 and associated data and components may be described in regard to these examples, any other UE and/or one or more other components, systems, and devices may be used to implement any one or more of examples described herein.

Example 501 illustrates an exemplary UE emergency status data 510 data structure representing UE emergency status data for a UE (e.g., the UE 110 as determined by the emergency status component 111). A data element 512 of the UE emergency status data 510 may indicate the primary PSAP status for the area associated with the UE, in this case that there is an active primary PSAP (and, in examples, that the UE is whitelisted for the PSAP). A data element 514 of the UE emergency status data 510 may indicate the redirection PSAP status for the area associated with the UE, in this case that there is an active redirection PSAP (and, in examples, that the UE is whitelisted for the PSAP). A data element 516 of the UE emergency status data 510 may indicate the signal strength associated with the UE (e.g., base station signal strength, UE signal strength), in this case that there is full signal strength available for emergency communications. Note that the data of the UE emergency status data 510 may be represented as flags or any other indicator that may suitably represent the information described herein.

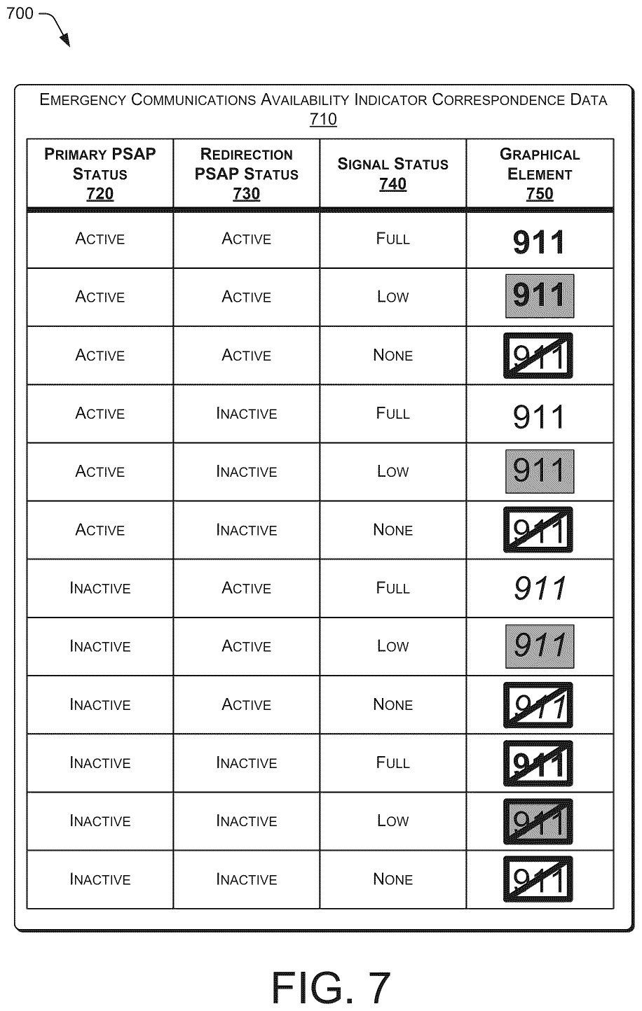

Based on the status data represented in the UE emergency status data 510, the UE (e.g., the UE 110 as operating in conjunction with the emergency status component 111) may generate the interface element 518. As shown here, in examples, this emergency communications availability interface element may be a representation of “911” in a particular manner. For instance, where there is both a primary and redirection PSAP active and where the signal strength is good as in the example 501, the interface element 518 may be generated by the UE as large, bold, and/or in a particular color (e.g., green) that may readily indicate to a user that emergency communications are fully available. In examples, there may be a set of multiple indicators available, each of which may be associated with a particular combination of primary PSAP status, redirection PSAP status, and signal status. An example of this correspondence data is provided in FIG. 7. An emergency status component may be configured to determine a graphical element representing a UE's emergency communications availability using such correspondence data and the data representing the determined particular combination of primary PSAP status, redirection PSAP status, and signal status.

In examples, alternative and/or additional indications of emergency communications availability may be generated and presented to a user at the UE. For example, the UE may be configured to generate a particular sound in response to determining a particular emergency communications availability status (e.g., based on a particular combination of primary PSAP status, redirection PSAP status, and signal status). The UE may also, or instead, be configured to generate a particular haptic indication (e.g., vibrate the UE) in response to determining a particular emergency communications availability status (e.g., based on a particular combination of primary PSAP status, redirection PSAP status, and signal status). In some examples, such haptic and/or audible indications may be generated when the emergency communications availability status determined at a UE changes from a previous emergency communications availability status to an updated (different) emergency communications availability status. For instance, it may be useful for a user to know that full emergency communications availability has been restored from no or partial emergency communications availability or that emergency communications availability has ceased after previously having full emergency communications availability. Any other indications of emergency communications availability statuses, and any triggering conditions for presenting such indication, may be implemented according to the disclosed systems and techniques.

Example 502 of FIG. 5 illustrates an exemplary UE emergency status data 520 data structure representing UE emergency status data for a UE (e.g., the UE 110 as determined by the emergency status component 111). A data element 522 of the UE emergency status data 520 may indicate the primary PSAP status for the area associated with the UE, in this case that there is an active primary PSAP (and, in examples, that the UE is whitelisted for the PSAP). A data element 524 of the UE emergency status data 520 may indicate the redirection PSAP status for the area associated with the UE, in this case that there is no active redirection PSAP (or, in some examples, because the UE is not whitelisted or is blacklisted for a particular redirection PSAP). A data element 526 of the UE emergency status data 520 may indicate the signal strength associated with the UE (e.g., base station signal strength, UE signal strength), in this case that there is full signal strength available for emergency communications. As with the other examples, the data of the UE emergency status data 520 may be represented as flags or any other indicator that may suitably represent the information described herein.

Based on the status data represented in the UE emergency status data 520, the UE (e.g., the UE 110 as operating in conjunction with the emergency status component 111) may generate the interface element 528. As shown here, in examples, this emergency communications availability interface element may be a representation of “911” in a particular manner. For instance, where there is only a primary PSAP and no redirection PSAP active, even though the signal strength is good, as in the example 502, the interface element 528 may be generated by the UE as smaller, not bold, and/or in a particular color (e.g., yellow) that may readily indicate to a user that emergency communications are partially available. As noted, there may be a set of multiple indicators available, each of which may be associated with a particular combination of primary PSAP status, redirection PSAP status, and signal status. An example of this correspondence data is provided in FIG. 7. An emergency status component may be configured to determine a graphical element representing a UE's emergency communications availability using such correspondence data and the data representing the determined particular combination of primary PSAP status, redirection PSAP status, and signal status.

Example 503 of FIG. 5 illustrates an exemplary UE emergency status data 530 data structure representing UE emergency status data for a UE (e.g., the UE 110 as determined by the emergency status component 111). A data element 532 of the UE emergency status data 530 may indicate the primary PSAP status for the area associated with the UE, in this case that there is no active primary PSAP (or, in some examples, because the UE is not whitelisted or is blacklisted for a particular primary PSAP). A data element 534 of the UE emergency status data 530 may indicate the redirection PSAP status for the area associated with the UE, in this case that there is an active redirection PSAP (and, in examples, that the UE is whitelisted for the PSAP). A data element 536 of the UE emergency status data 530 may indicate the signal strength associated with the UE (e.g., base station signal strength, UE signal strength), in this case that there is full signal strength available for emergency communications. As with the other examples, the data of the UE emergency status data 530 may be represented as flags or any other indicator that may suitably represent the information described herein.

Based on the status data represented in the UE emergency status data 530, the UE (e.g., the UE 110 as operating in conjunction with the emergency status component 111) may generate the interface element 538. As shown here, in examples, this interface element may be a representation of “911” in a particular manner. For instance, where there is no active primary PSAP and only a redirection PSAP active, even though the signal strength is good, as in the example 503, the interface element 538 may be generated by the UE as smaller, italicized, and/or in a particular color (e.g., yellow) that may readily indicate to a user that emergency communications are partially available. As noted, there may be a set of multiple indicators available, each of which may be associated with a particular combination of primary PSAP status, redirection PSAP status, and signal status. An example of this correspondence data is provided in FIG. 7. An emergency status component may be configured to determine a graphical element representing a UE's emergency communications availability using such correspondence data and the data representing the determined particular combination of primary PSAP status, redirection PSAP status, and signal status.

FIG. 6 illustrates further examples of data structures and graphical elements that may be generated based on such data structures. Example 601 illustrates an exemplary UE emergency status data 610 data structure representing UE emergency status data for a UE (e.g., the UE 110 as determined by the emergency status component 111). A data element 612 of the UE emergency status data 610 may indicate the primary PSAP status for the area associated with the UE, in this case that there is an active primary PSAP (and, in examples, that the UE is whitelisted for the PSAP). A data element 614 of the UE emergency status data 610 may indicate the redirection PSAP status for the area associated with the UE, in this case that there is an active redirection PSAP (and, in examples, that the UE is whitelisted for the PSAP). A data element 616 of the UE emergency status data 610 may indicate the signal strength associated with the UE (e.g., base station signal strength, UE signal strength), in this case that there is low signal strength available for emergency communications. Note that the data of the UE emergency status data 610 may be represented as flags or any other indicator that may suitably represent the information described herein.

Based on the status data represented in the UE emergency status data 610, the UE (e.g., the UE 110 as operating in conjunction with the emergency status component 111) may generate the interface element 618. As shown here, in examples, this interface element may be a representation of “911” in a particular manner. For instance, where there is both a primary and redirection PSAP active and where the signal strength is low as in the example 601, the interface element 618 may be generated by the UE as large, bold, and/or in a particular color (e.g., green) indicating the PSAP status, but with a background or shading indicating a less than normal signal strength. Here, the “911” indication is on a shaded background (e.g., of any color) indicating low signal strength. In the examples of FIG. 5, where in each example the signal strength is sufficient, there may be no background shading or some other indication may be used to indicate that there is full signal strength available for emergency communications. The interface element 618 may readily indicate to a user that emergency communications are partially available in that primary and redirection PSAPs are active, but the signal strength is low. In examples, there may be a set of multiple indicators available, each of which may be associated with a particular combination of primary PSAP status, redirection PSAP status, and signal status. An example of this correspondence data is provided in FIG. 7. An emergency status component may be configured to determine a graphical element representing a UE's emergency communications availability using such correspondence data and the data representing the determined particular combination of primary PSAP status, redirection PSAP status, and signal status.

Example 602 of FIG. 6 illustrates an exemplary the UE emergency status data 620 data structure representing UE emergency status data for a UE (e.g., the UE 110 as determined by the emergency status component 111). A data element 622 of the UE emergency status data 620 may indicate the primary PSAP status for the area associated with the UE, in this case that there is an active primary PSAP (and, in examples, that the UE is whitelisted for the PSAP). A data element 624 of the UE emergency status data 620 may indicate the redirection PSAP status for the area associated with the UE, in this case that there is an active redirection PSAP (and, in examples, that the UE is whitelisted for the PSAP). A data element 626 of the UE emergency status data 620 may indicate the signal strength associated with the UE (e.g., base station signal strength, UE signal strength), in this case that there is no signal strength and therefore no signal available for emergency communications. As with the other examples, the data of the UE emergency status data 620 may be represented as flags or any other indicator that may suitably represent the information described herein.

Based on the status data represented in the UE emergency status data 620, the UE (e.g., the UE 110 as operating in conjunction with the emergency status component 111) may generate the interface element 628. As shown here, in examples, this interface element may be a representation of “911” in a particular manner. For instance, regardless of there being a both a primary PSAP and a redirection PSAP active, where the signal strength corresponds to no signal, as in the example 602, the interface element 628 may be generated by the UE as crossed out, in a particular color (e.g., red), and/or in a manner that may readily indicate to a user that emergency communications are not available. As noted, there may be a set of multiple indicators available, each of which may be associated with a particular combination of primary PSAP status, redirection PSAP status, and signal status. An example of this correspondence data is provided in FIG. 7. An emergency status component may be configured to determine a graphical element representing a UE's emergency communications availability using such correspondence data and the data representing the determined particular combination of primary PSAP status, redirection PSAP status, and signal status.

Example 603 of FIG. 6 illustrates an exemplary UE emergency status data 630 data structure representing UE emergency status data for a UE (e.g., the UE 110 as determined by the emergency status component 111). A data element 632 of the UE emergency status data 630 may indicate the primary PSAP status for the area associated with the UE, in this case that there is no active primary PSAP (or, in examples, because the UE is not whitelisted or is blacklisted for a particular primary PSAP). A data element 634 of the UE emergency status data 630 may indicate the redirection PSAP status for the area associated with the UE, in this case that there is no active redirection PSAP (or, in examples, because the UE is not whitelisted or is blacklisted for a particular redirection PSAP). A data element 636 of the UE emergency status data 630 may indicate the signal strength associated with the UE (e.g., base station signal strength, UE signal strength), in this case that there is full signal strength available for emergency communications. As with the other examples, the data of the UE emergency status data 630 may be represented as flags or any other indicator that may suitably represent the information described herein.

Based on the status data represented in the UE emergency status data 630, the UE (e.g., the UE 110 as operating in conjunction with the emergency status component 111) may generate the interface element 638. As shown here, in examples, this interface element may be a representation of “911” in a particular manner. For instance, where there is no active primary PSAP or active redirection PSAP, even though the signal strength is good, as in the example 603, the interface element 638 may be generated by the UE as crossed out, in a particular color (e.g., red), and/or in a manner that may readily indicate to a user that emergency communications are not available. As noted, there may be a set of multiple indicators available, each of which may be associated with a particular combination of primary PSAP status, redirection PSAP status, and signal status. An example of this correspondence data is provided in FIG. 7. An emergency status component may be configured to determine a graphical element representing a UE's emergency communications availability using such correspondence data and the data representing the determined particular combination of primary PSAP status, redirection PSAP status, and signal status.

FIG. 7 illustrates an exemplary data structure 700 representing emergency communications availability indicator correspondence data 710. The data 710 may include data representing primary PSAP status 720, redirection PSAP status 730, signal status 740, and graphical element 750. In some examples, the data 710 may also, or instead, include whitelist and/or blacklist data that may indicate an associated authorization status for a primary and/or redirection PSAP. This data may be further used to determine the associated graphical elements (e.g., emergency communications availability determination may be made for PSAPs for which the UE is authorized (whitelisted) or not unauthorized (blacklisted). As shown here, particular combinations of the statuses may correspond to particular graphical elements. The graphical elements shown here are for exemplary purposes only and other permutations of graphical element attributes are contemplated. Specifically, it is contemplated that colors may be an effective means of conveying to a user whether emergency communications are available. For instance, a green graphical element may indicate full emergency communications availability, a yellow graphical element may indicate partial emergency communications availability (e.g., only one of a primary PSAP or a redirection PSAP is active), and a red graphical element may indicate no emergency communications availability (e.g., due to no signal or neither primary nor redirection PSAP active).

As shown here, combinations of graphical element attributes may be used to indicate various statuses. For example, the bold lettering of “911” may indicate that both a primary PSAP and a redirection PSAP are active, while background shading (or lack thereof) may indicate a signal status. Alternatively or additionally, general graphical element attributes may be used to indicate a general emergency communications availability. For example, crossed out lettering of “911” may indicate that emergency communications are not available regardless of reason. As will be appreciated, any combination of colors, text, shading, font effects, etc. may be used to indicate various types and levels of emergency communications availability, and all such combinations are contemplated as within the scope of instant disclosure.

In examples, instead of or in addition to visual indications of emergency communications availability, a UE may present audible or haptic indications of the particular combinations of the statuses represented by the emergency communications availability indicator correspondence data 710. For example, the UE may be configured to generate a particular sound in response to determining a particular emergency communications availability status (e.g., based on a particular combination of primary PSAP status, redirection PSAP status, and signal status). The UE may also, or instead, be configured to generate a particular haptic indication (e.g., vibrate the UE) in response to determining a particular emergency communications availability status (e.g., based on a particular combination of primary PSAP status, redirection PSAP status, and signal status). Any other indications of emergency communications availability statuses may be implemented according to the disclosed systems and techniques.

### Example User Equipment

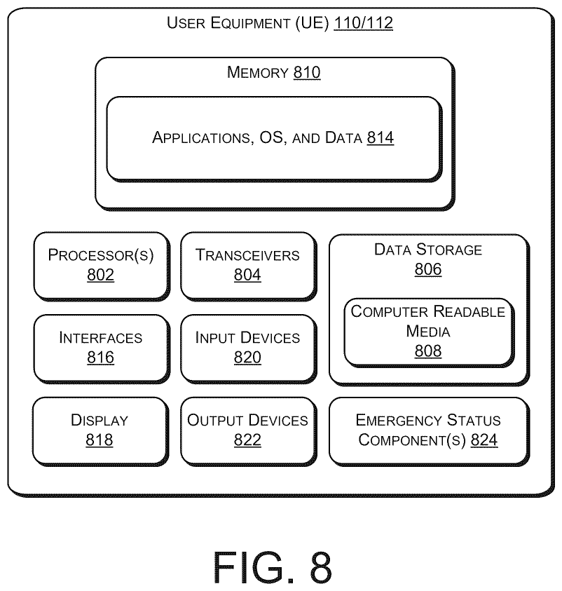

FIG. 8 is an example of a UE, such as UE 110 or UE 112, for use with the systems and methods disclosed herein, in accordance with some examples of the present disclosure. The UE 110/112 may include one or more processors 802, one or more transmit/receive antennas (e.g., transceivers or transceiver antennas) 804, and a data storage 806. The data storage 806 may include a computer readable media 808 in the form of memory and/or cache. This computer-readable media may include a non-transitory computer-readable media. The processor(s) 802 may be configured to execute instructions, which can be stored in the computer readable media 808 and/or in other computer readable media accessible to the processor(s) 802. In some configurations, the processor(s) 802 is a Central Processing Unit (CPU), a Graphics Processing Unit (GPU), or both CPU and GPU, or any other sort of processing unit. The transceiver antenna(s) 804 can exchange signals with a base station, such as base stations 120 and 122.

The UE 110/112 may be configured with a memory 810. The memory 810 may be implemented within, or separate from, the data storage 806 and/or the computer readable media 808. The memory 810 may include any available physical media accessible by a computing device to implement the instructions stored thereon. For example, the memory 810 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 110/112.

The memory 810 can store several modules, such as instructions, data stores, and so forth that are configured to execute on the processor(s) 802. In configurations, the memory 810 may also store one or more applications 814 configured to receive and/or provide voice, data, and messages (e.g., emergency communications messages, SMS messages, Multi-Media Message Service (MMS) messages, Instant Messaging (IM) messages, Enhanced Message Service (EMS) messages, etc.) to and/or from another device or component (e.g., the base stations 120 and 122). The applications 814 may also include one or more operating systems and/or one or more third-party applications that provide additional functionality to the UE 110/112.

Although not all illustrated in FIG. 8, the UE 110/112 may also comprise various other components, e.g., a battery, a charging unit, one or more network interfaces 816, an audio interface, a display 818, a keypad or keyboard, and one or more input devices 820, and one or more output devices 822. The UE 110/112 may further include one or more emergency status components 824 that may be configured to determine emergency communications availability data that may be used as described herein for generating and presenting emergency communications graphical elements on a UE.

### Example Computing Device

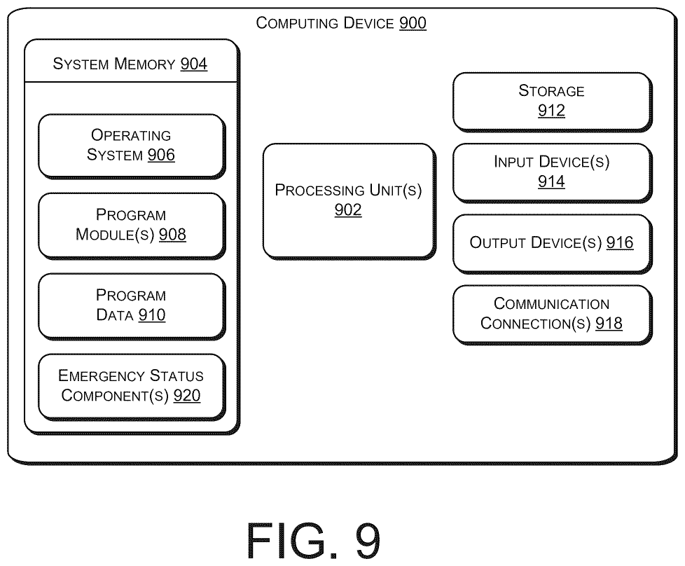

FIG. 9 is an example of a computing device 900 for use with the systems and methods disclosed herein, in accordance with some examples of the present disclosure. The computing device 900 can be used to implement various components of a core network, a base station, and/or any servers, routers, gateways, gateway elements, administrative components, etc. that can be used by a communication provider. One or more computing devices 900 can be used to implement the network 101, for example. One or more computing devices 900 can also be used to implement base stations and other components.

In various embodiments, the computing device 900 can include one or more processing units 902 and system memory 904. Depending on the exact configuration and type of computing device, the system memory 904 can be volatile (such as RAM), nonvolatile (such as ROM, flash memory, etc.) or some combination of the two. The system memory 904 can include an operating system 906, one or more program modules 908, program data 910, and one or more emergency status components 920. The system memory 904 may be secure storage or at least a portion of the system memory 904 can include secure storage. The secure storage can prevent unauthorized access to data stored in the secure storage. For example, data stored in the secure storage can be encrypted or accessed via a security key and/or password.

The computing device 900 can also include additional data storage devices (removable and/or non-removable) such as, for example, magnetic disks, optical disks, or tape. Such additional storage is illustrated in FIG. 9 by storage 912.

Non-transitory computer storage media of the computing device 900 can include volatile and nonvolatile, removable and non-removable media implemented in any method or technology for storage of information, such as computer readable instructions, data structures, program modules, or other data. The system memory 904 and storage 912 are examples of computer readable storage media. Non-transitory computer readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 900. Any such non-transitory computer readable storage media can be part of the computing device 900.

In various embodiment, any or all of the system memory 904 and storage 912 can store programming instructions which, when executed, implement some or all of the functionality described above as being implemented by one or more systems configured in the environment 100 and/or components of the network 101.

The computing device 900 can also have one or more input devices 914 such as a keyboard, a mouse, a touch-sensitive display, voice input device, etc. The computing device 900 can also have one or more output devices 916 such as a display, speakers, a printer, etc. can also be included. The computing device 900 can also contain one or more communication connections 918 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.
A: A method performed by one or more computing devices configured in a wireless communications network, the method comprising receiving, at a user equipment (UE) from a wireless communications network component, public safety access point (PSAP) status data; determining, at the UE, signal status data associated with a wireless communications signal received at the UE; determining, at the UE, based at least in part on the signal status data and the PSAP status data, an emergency communications availability interface element from among a plurality of emergency communications availability interface elements; and generating, at the UE, a user interface comprising the emergency communications availability interface element.
B: The method of paragraph A, wherein the PSAP status data comprises primary PSAP status data and redirection PSAP status data.
C: The method of paragraph A or B, wherein determining the signal status data comprises determining a signal strength of the wireless communications signal; determining whether the signal strength meets or exceeds a no signal threshold; and determining the signal status data based at least in part on whether the signal strength meets or exceeds the no signal threshold.
D: The method of paragraph C, wherein determining the signal status data further comprises determining that the signal strength meets or exceeds the no signal threshold; based at least in part on determining that the signal strength meets or exceeds the no signal threshold, determining whether the signal strength meets or exceeds a low signal threshold; and determining the signal status data further based at least in part on whether the signal strength meets or exceeds the low signal threshold.
E: The method of any of paragraphs A-D, wherein the emergency communications availability interface element comprises a first interface element attribute associated with the PSAP status data and a second interface element attribute associated with the signal status data, and the first interface element attribute is distinct from the second interface element attribute.
F: The method of any of paragraphs A-E, wherein the PSAP status data comprises an indication of a wireless communications network area associated with the UE.
G: A user equipment (UE) comprising one or more processors; one or more transceivers; a display; and non-transitory computer-readable media storing computer-executable instructions that, when executed by the one or more processors, cause the one or more processors to perform operations comprising receiving public safety access point (PSAP) status data from a wireless communications network; determining signal status data associated with a wireless s communications signal received from the wireless communications network; determining, based at least in part on the signal status data and the PSAP status data, an emergency communications availability interface element from among a plurality of emergency communications availability interface elements; and generating, on the display, a user interface comprising the emergency communications availability interface element.
H: The UE of paragraph G, wherein the PSAP status data comprises one or more of primary PSAP status data for a wireless communications network area associated with the UE, or redirection PSAP status data for the wireless communications network area associated with the UE.
I: The UE of paragraph H, wherein determining the emergency communications availability interface element is further based at least in part on one or more of the primary PSAP status data or the redirection PSAP status data.
J: The UE of any of paragraphs G-I, wherein determining the signal status data comprises determining a signal strength of the wireless communications signal; determining whether the signal strength meets or exceeds a first signal threshold; and determining the signal status data based at least in part on whether the signal strength meets or exceeds the first signal threshold.
K: The UE of paragraph J, wherein determining the signal status data further comprises determining that the signal strength meets or exceeds the first signal threshold; based at least in part on determining that the signal strength meets or exceeds the first signal threshold, determining whether the signal strength meets or exceeds a second signal threshold; and determining the signal status data further based at least in part on whether the signal strength meets or exceeds the second signal threshold.
L: The UE of paragraphs K, wherein determining the signal status data further comprises determining that the signal strength does not meet or exceed the second signal threshold; and determining the signal status data further based at least in part on determining that the signal strength does not meet or exceed the second signal threshold.
M: The UE of any of paragraphs G-L, wherein the operations further comprise generating, based at least in part on the signal status data and the PSAP status data, one or more of an audible indication corresponding to the emergency communications availability interface element or a haptic indication corresponding to the emergency communications availability interface element.
N: The UE of any of paragraphs G-M, wherein the PSAP status data comprises data aggregated from data received from a plurality of PSAPs associated with the wireless communications network, wherein the plurality of PSAPs comprises at least one PSAP associated with a wireless communications network area associated with the UE.
O: A non-transitory computer-readable media storing computer-executable instructions that, when executed by one or more processors, cause the one or more processors to perform operations comprising receiving public safety access point (PSAP) status data from a PSAP in communication with a wireless communications network; determining a wireless communications network area for the PSAP; determining a PSAP area role for the PSAP in the wireless communications network area; generating a data structure for the wireless communications network area comprising an indication of the wireless communications network area, an indication of the PSAP, and an indication of the PSAP area role; and transmitting the data structure to a user equipment (UE) causing the UE to determine an emergency communications availability interface element based at least in part on the data structure; and generate a user interface comprising the emergency communications availability interface element.
P: The non-transitory computer-readable media of paragraph O, wherein determining the PSAP area role for the PSAP comprises one of determining that the PSAP is an active primary PSAP for the wireless communications network area; or determining that the PSAP is an active redirection PSAP for the wireless communications network area.
Q: The non-transitory computer-readable media of paragraph O or P, wherein transmitting the data structure to a UE further causes the UE to generate, based at least in part on the data structure, one or more of a haptic indication or an audible indication.
R: The non-transitory computer-readable media of any of paragraphs O-Q, wherein determining the PSAP area role for the PSAP in the wireless communications network area comprises determining that no PSAP status data has been received from the PSAP for at least a threshold period of time; and determining the PSAP area role for the PSAP comprises determining that the PSAP is inaction based at least in part on determining that no PSAP status data has been received from the PSAP for at least the threshold period of time.
S: The non-transitory computer-readable media of any of paragraphs O-R, wherein the PSAP status data comprises data indicating a first wireless communications network area for which the PSAP is a primary PSAP, and a second wireless communications network area for which the PSAP is a redirection PSAP.
T: The non-transitory computer-readable media of any of paragraphs O-S, wherein transmitting the data structure the UE caused the UE to determine the emergency communications availability interface element further based at least in part on signal status data associated with a wireless communications signal received from the wireless communications network.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A T.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by one or more computing devices configured in a wireless communications network, the method comprising:
receiving, at a user equipment (UE) from a wireless communications network component, public safety access point (PSAP) status data;
determining, at the UE, signal status data associated with a wireless communications signal received at the UE;
determining, at the UE, based at least in part on the signal status data and the PSAP status data, an emergency communications availability interface element from among a plurality of emergency communications availability interface elements; and
generating, at the UE, a user interface comprising the emergency communications availability interface element.

2. The method of claim 1, wherein the PSAP status data comprises primary PSAP status data and redirection PSAP status data.

3. The method of claim 1, wherein determining the signal status data comprises:
determining a signal strength of the wireless communications signal;
determining whether the signal strength meets or exceeds a no signal threshold; and
determining the signal status data based at least in part on whether the signal strength meets or exceeds the no signal threshold.

4. The method of claim 3, wherein determining the signal status data further comprises:
determining that the signal strength meets or exceeds the no signal threshold;
based at least in part on determining that the signal strength meets or exceeds the no signal threshold, determining whether the signal strength meets or exceeds a low signal threshold; and
determining the signal status data further based at least in part on whether the signal strength meets or exceeds the low signal threshold.

5. The method of claim 1, wherein:
the emergency communications availability interface element comprises a first interface element attribute associated with the PSAP status data and a second interface element attribute associated with the signal status data, and
the first interface element attribute is distinct from the second interface element attribute.

6. The method of claim 1, wherein the PSAP status data comprises an indication of a wireless communications network area associated with the UE.

7. A user equipment (UE) comprising:
one or more processors;
one or more transceivers;
a display; and
non-transitory computer-readable media storing computer-executable instructions that, when executed by the one or more processors, cause the one or more processors to perform operations comprising:
receiving public safety access point (PSAP) status data from a wireless communications network;
determining signal status data associated with a wireless communications signal received from the wireless communications network;
determining, based at least in part on the signal status data and the PSAP status data, an emergency communications availability interface element from among a plurality of emergency communications availability interface elements; and
generating, on the display, a user interface comprising the emergency communications availability interface element.

8. The UE of claim 7, wherein the PSAP status data comprises one or more of:
primary PSAP status data for a wireless communications network area associated with the UE, or
redirection PSAP status data for the wireless communications network area associated with the UE.

9. The UE of claim 8, wherein determining the emergency communications availability interface element is further based at least in part on one or more of the primary PSAP status data and the redirection PSAP status data.

10. The UE of claim 7, wherein determining the signal status data comprises:
determining a signal strength of the wireless communications signal;
determining whether the signal strength meets or exceeds a first signal threshold; and
determining the signal status data based at least in part on whether the signal strength meets or exceeds the first signal threshold.

11. The UE of claim 10, wherein determining the signal status data further comprises:
determining that the signal strength meets or exceeds the first signal threshold;
based at least in part on determining that the signal strength meets or exceeds the first signal threshold, determining whether the signal strength meets or exceeds a second signal threshold; and
determining the signal status data further based at least in part on whether the signal strength meets or exceeds the second signal threshold.

12. The UE of claim 11, wherein determining the signal status data further comprises:
determining that the signal strength does not meet or exceed the second signal threshold; and
determining the signal status data further based at least in part on determining that the signal strength does not meet or exceed the second signal threshold.

13. The UE of claim 7, wherein the operations further comprise generating, based at least in part on the signal status data and the PSAP status data, one or more of an audible indication corresponding to the emergency communications availability interface element or a haptic indication corresponding to the emergency communications availability interface element.

14. The UE of claim 7, wherein the PSAP status data comprises data aggregated from data received from a plurality of PSAPs associated with the wireless communications network, wherein the plurality of PSAPs comprises at least one PSAP associated with a wireless communications network area associated with the UE.

15. A non-transitory computer-readable media storing computer-executable instructions that, when executed by one or more processors, cause the one or more processors to perform operations comprising:
receiving public safety access point (PSAP) status data from a PSAP in communication with a wireless communications network;
determining a wireless communications network area for the PSAP;
determining a PSAP area role for the PSAP in the wireless communications network area;
generating a data structure for the wireless communications network area comprising an indication of the wireless communications network area, an indication of the PSAP, and an indication of the PSAP area role; and
transmitting the data structure to a user equipment (UE) causing the UE to:
determine an emergency communications availability interface element based at least in part on the data structure; and
generate a user interface comprising the emergency communications availability interface element.

16. The non-transitory computer-readable media of claim 15, wherein determining the PSAP area role for the PSAP comprises one of:
determining that the PSAP is an active primary PSAP for the wireless communications network area; or
determining that the PSAP is an active redirection PSAP for the wireless communications network area.

17. The non-transitory computer-readable media of claim 15, wherein transmitting the data structure to a UE further causes the UE to generate, based at least in part on the data structure, one or more of a haptic indication or an audible indication.

18. The non-transitory computer-readable media of claim 15, wherein determining the PSAP area role for the PSAP in the wireless communications network area comprises:
determining that no PSAP status data has been received from the PSAP for at least a threshold period of time; and
determining the PSAP area role for the PSAP comprises determining that the PSAP is inaction based at least in part on determining that no PSAP status data has been received from the PSAP for at least the threshold period of time.

19. The non-transitory computer-readable media of claim 15, wherein the PSAP status data comprises data indicating:
a first wireless communications network area for which the PSAP is a primary PSAP, and
a second wireless communications network area for which the PSAP is a redirection PSAP.

20. The non-transitory computer-readable media of claim 15, wherein transmitting the data structure the UE caused the UE to determine the emergency communications availability interface element further based at least in part on signal status data associated with a wireless communications signal received from the wireless communications network.
